(19) United States
(12) Patent Application Publication
(10) Pub. No.: US 2010/0172678 A1
(43) Pub. Date: Jul. 8, 2010

(54) IMAGE FORMING APPARATUS

(75) Inventor: Sin Ae Kim, Suwon-si (KR)

Correspondence Address: DLA PIPER LLP US, P. O. BOX 2758, RESTON, VA, 20195, US

(73) Assignee: SAMSUNG ELECTRONICS CO., LTD., Suwon-si (KR)

(21) Appl. No.: 12/649,811

(22) Filed: Dec. 30, 2009

(30) Foreign Application Priority Data
Jan. 2, 2009 (KR) 10-2009-0000127

(51) Int. Cl. G03G 15/00

(52) U.S. Cl. 399/393

(57) ABSTRACT

Disclosed herein is an image forming apparatus that can include a main body, a paper cassette detachably mounted on the main body and a manual paper feed tray provided separately from the paper cassette. Both the cassette and the manual tray can receive a printing medium to be picked up by a pick up roller for forming an image. The tray can be received into and pulled out from so as to allow the placement of the printing medium on the tray and the positioning of the printing medium for pick up by the pick up roller. One or more guides can further be provided to align the printing medium placed on the tray into suitable pick up orientation.

### CROSS-REFERENCE TO RELATED APPLICATION

This application claims the benefit of Korean Patent Application No. 2009-0000127, filed on Jan. 2, 2009 in the Korean Intellectual Property Office, the disclosure of which is incorporated herein by reference in its entirety.

### TECHNICAL FIELD

Embodiments of the present disclosure generally relate to an image forming apparatus having an improved paper feeding tray.

### BACKGROUND OF RELATED ART

Generally, an image forming apparatus refers to an apparatus that forms images on a printing medium in accordance with input image signals. Examples of such an apparatus include a printer, a copier, a facsimile and a multifunctional apparatus that combines some of the functionalities of those afore-mentioned apparatuses.

The image forming apparatus can be provided with a paper feeding device to supply paper to be used in the image forming apparatus. The paper feeding device can include a paper feeding cassette and a paper feeding tray. The paper feeding cassette can store multiple sheets of paper, and is generally used for automatic paper supply. The paper feeding tray can be generally used to supply a single sheet of paper or to manually supply various sizes of paper.

A main body of the image forming apparatus can include an opening so that a user can place the paper in the paper feeding tray mounted in the main body. Moreover, the image forming apparatus can include a pick-up unit which may be disposed above the inner end of the paper feeding tray, and which may be configured to pick up the paper from the paper feeding tray. The image forming apparatus can also include a feed roller disposed above the paper feeding tray to feed the paper from the paper feeding tray to the pick-up unit.

Moreover, a guide unit can be disposed at an outer end of the paper feeding tray, where the opening is formed, to guide various sizes of the paper. More particularly, the guide unit can include a pair of paper guides that are movable in a width direction of the paper. When the paper is placed on the paper feeding tray, spacing between the paper guides can be adjusted to correspond to the width of the paper so that both lateral edges of the paper can be guided by the paper guides.

Once the user places the paper on the paper feeding tray through the opening and adjusts the guide unit so that the both lateral edges of the paper are supported by the guide unit, the image forming apparatus can be started and the feed roller(s) rotate to feed the paper toward the pick-up unit.

According to the above-described configuration of an image forming apparatus, the height of the main body may need to be increased to secure a mounting space for the feed roller used to move the paper put on the paper feeding tray.

Moreover, paper could often be incorrectly orientated or aligned when being fed to the pick-up unit by the feed roller. When that occurs, images that are printed on the paper can be skewed or inclined, thereby adversely impacting the printing quality. Even of more concern may be that the paper is likely to jam in a paper feeding path when the feeding orientation is wrong.

### SUMMARY OF THE DISCLOSURE

In accordance with one aspect of the present disclosure, an image forming apparatus can include a main body, a printing medium cassette and a printing medium tray. The printing medium cassette may be detachably supported in the main body. The printing medium tray may be provided on the main body separately from the printing medium cassette. Each of the printing medium cassette and the printing medium tray may be configured to receive one or more printing media on which to form an image. The printing medium tray may be configured to move between a first position in which the printing medium tray is withdrawn from the main body to allow placement of a printing medium on the printing medium tray and a second position in which the printing medium tray is received into the main body to allow the printing medium placed on the printing medium tray to be picked up.

The printing medium tray may include a stopper configured to come into an interfering contact with, and to thereby align, a leading edge of the printing medium placed on the tray.

The image forming apparatus may further comprise a pick-up roller disposed above an end of the printing medium tray when the printing medium tray is in the second position. The pick-up roller may be configured to pick up the printing medium selectively from the printing medium tray and from the printing medium cassette.

The stopper may include a blocking portion extending downward so as to come into a contact with and to thereby align the leading edge of the printing medium.

The printing medium tray may include a guide disposed at an inner end of the printing medium tray in such a manner to guide the leading edge of the printing medium toward the stopper. The inner end of the printing medium tray may be the leading end of the printing medium tray with respect to a movement of the printing medium from the first position to the second position.

The printing medium tray may includes a shutter pivotably mounted at the inner end of the printing medium tray. The shutter may comprise a blocking portion configured to come into an interfering contact with, and to thereby align, the leading edge of the printing medium.

The shutter may includes a first protrusion formed on a side thereof. The main body may include a second protrusion configured to interferingly contact the first protrusion of the shutter so as to cause the shutter to pivot in a direction moving the blocking portion of the shutter away from the leading edge of the printing medium as the printing medium tray moves from the first position to the second position.

The main body may define an opening through which the printing medium tray may be received into the main body. The printing medium tray may include a cover formed at an outer end opposite the leading end of the printing medium tray. The cover may be configured to open and to close the opening.

The cover may be pivotably mounted on the outer end of the tray.

The image forming apparatus may further comprise side guides configured to collectively guide both sides of the printing medium placed on the printing medium tray.

The stopper may be formed integrally with at least one of the side guides.

The side guides may be configured to be movable along a width direction of the printing medium. The image forming apparatus may further comprise a rack gear connected to each of the side guides and a pinion interconnecting the rack gears.

The image forming apparatus may further comprise a rail assembly configured to allow the printing medium tray to move between the first and second positions.

The rail assembly may comprise first rails that may be movably mounted on both sides of the printing medium tray and second rails that may be mounted on the main body and movably coupled to the first rails.

The image forming apparatus may further comprise an elastic support member provided on one of the main body and the printing medium tray. The elastic support member being configured elastically bias the printing medium tray to move away from the main body toward the first position.

The image forming apparatus may further comprise locking members provided on the main body and the printing medium tray. The locking members may be configured to engage each other so as to hold the printing medium in place within the main body.

According to another aspect of the present disclosure, an image forming apparatus may be provided to comprise a main body, a printing medium tray and a printing medium guide. The printing medium tray may include a tray surface on which a printing medium is to be placed, and may be movably received in the main body so as to be capable of being at least partially protruding from the main body. The printing medium guide may be disposed adjacent the tray surface, and may be configured to guide movement of the printing medium placed on the tray surface.

The printing medium guide may include a stopper having a portion configured to align a leading edge of the printing medium.

The printing medium guide may include side guides configured to guide both lateral edges of the printing medium.

The stopper may be integrally formed with at least one the side guides.

The printing medium tray may include a guide disposed at an inner end of the printing medium tray in such a manner to guide the leading edge of the printing medium toward the stopper. The inner end of the printing medium tray may be the leading end of the printing medium tray with respect to a movement of the printing medium in a direction of being received into the main body.

According to yet another aspect, an image forming apparatus that may include a main body in which is supported a printing unit that forms an image on a printing medium may be provided to include a pick up roller, a printing medium cassette and a printing medium tray. The pick up roller may be supported in the main body. The printing medium cassette may be detachably receivable in the main body, and may be configured to receive therein a first capacity of printing media. The printing medium tray may be movably receivable in the main body, and may be configured to receive therein a second capacity of printing media less than the first capacity of printing media. The pick up roller may be configured to pick up the printing medium selectively from the printing medium cassette and from the printing medium tray, and may be configured to convey the picked up printing media along a printing medium path toward the printing unit. The printing medium tray may be configured to move between a first position in which the tray is at least partially withdrawn from the main body to allow placement of printing media on the printing medium tray and a second position in which the printing medium tray is received into the main body to allow the printing medium placed on the printing medium tray to be picked up by the pick up roller.

The image forming apparatus may further comprise a printing medium guide disposed adjacent the printing medium tray and configured to align the printing medium placed on the printing medium tray.

The printing medium guide may include a blocking portion configured to come into an interfering contact with, and to thereby align, a leading edge of the printing medium placed on the printing medium tray.

The printing medium guide may be pivotably mounted at an end of the printing medium tray in such a manner the printing medium guide pivots in a direction moving the blocking portion of the printing medium guide away from as the leading edge of the printing medium as the printing medium tray moves into the main body.

### BRIEF DESCRIPTION OF THE DRAWINGS

Various aspects of the disclosure will become apparent and more readily appreciated from the following description of the embodiments, taken in conjunction with the accompanying drawings, in which:

FIGS. 1-3 are cross-sectional views schematically showing the operation of a paper feeding tray applied to an image forming apparatus according to an embodiment of the present disclosure;

FIG. 4 is an exploded perspective view of the paper feeding tray according to an embodiment;

FIG. 5 is a perspective view showing the paper feeding tray mounted in an image forming apparatus according to an embodiment;

FIG. 6 is a perspective view showing a paper feeding tray applied to an image forming apparatus, according to another embodiment of the present disclosure; and

FIG. 7 is a view illustrative of the operation of the paper feeding tray of FIG. 6.

### DETAILED DESCRIPTION OF SEVERAL EMBODIMENTS

Reference will now be made in detail to the embodiment, examples of which are illustrated in the accompanying drawings, wherein like reference numerals refer to like elements throughout. While the embodiments are described with detailed construction and elements to assist in a comprehensive understanding of the various applications and advantages of the embodiments, it should be apparent however that the embodiments can be carried out without those specifically detailed particulars. Also, well-known functions or constructions will not be described in detail so as to avoid obscuring the description with unnecessary detail. It should be also noted that in the drawings, the dimensions of the features are not intended to be to true scale and may be exaggerated for the sake of allowing greater understanding.

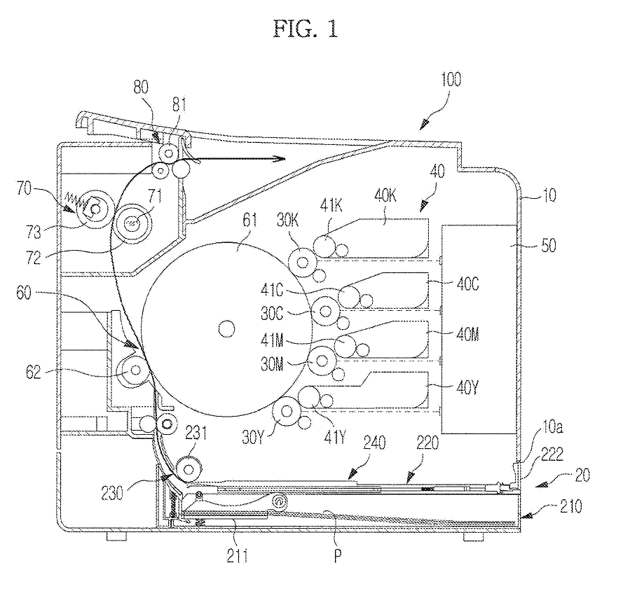

As shown in FIG. 1, an image forming apparatus 100 according to an embodiment of the present disclosure can include a main body 10 that can define the overall exterior appearance of the image forming apparatus 100, a paper feeding device 20 configured to store and to supply paper P for use in the image forming apparatus 100, multiple photoconductive mediums 30K, 30C, 30M and 30Y, each of which having a surface on which an electrostatic latent image can be formed, a developing device 40 configured to develop the electrostatic latent images formed on the photoconductive mediums 30K, 30C, 30M and 30Y into visible images using toner, an exposure device 50 configured to form the electrostatic latent images on the photoconductive mediums 30K, 30C, 30M and 30Y, a transfer device 60 configured to transfer the visible images to the paper P, a fixing device 70 configured to fix the transferred visible image to the paper P and a paper discharge device 80 configured to discharge the paper out of the image forming apparatus 100 when the image printing is completed.

The exposure device 50 can form the electrostatic latent images by emitting light having image data to the photoconductive mediums 30K, 30C, 30M and 30Y.

The developing device 40 can form the visible images by supplying toner to the electrostatic latent images formed on the photoconductive mediums 30K, 30C, 30M and 30Y. According to an embodiment, the developing device 40 can include four developing machines 40K, 40C, 40M and 40Y that store, respectively, black (B), magenta (M), cyan (C) and yellow (Y) toners therein. The developing machines 40K, 40C, 40M and 40Y can include developing rollers 41K, 41C, 41M and 41Y, respectively, which are configured to supply toner to the photoconductive mediums 30K, 30C, 30M and 30Y and to thereby form the visible images.

The transfer device 60 can include an intermediate transfer drum 61, to which the toner from the photoconductive mediums 30K, 30C, 30M and 30Y can be supplied, and a transfer roller 62 configured to transfer the toner from the intermediate transfer drum 61 to the paper P. The visible images formed on the photoconductive mediums 30K, 30C, 30M and 30Y can be sequentially transferred on the intermediate transfer drum 61 in an overlapping manner. The overlapped color images can be transferred on the paper P as the paper P pass between the transfer roller 62 and the intermediate transfer drum 61.

The fixing device 70 can include a heating roller 72 having a heater 71 disposed therein and a pressing roller 73 configured to press the paper P against the heating roller 72. As the paper P passes between the heating roller 72 and the pressing roller 73, heat and pressure can be applied to the paper P such that the visible images become fixed to the paper P.

The paper discharging device 80 can include multiple discharging rollers 81 mounted in sequence to discharge the toner-fixed paper P received from the fixing device 70 to the outside of the main body 10.

The paper feeding device 20 can include a paper feeding cassette 210, a paper feeding tray 220 and a pick-up unit 230. The paper feeding cassette 210 can be mounted on the main body 10, and can be movable in a forward (i.e., into the main body 10) and/or a backward direction (i.e., out of the main body 10) similarly to a drawer. The paper feeding cassette 210 can be used for automatic feeding of the paper P by storing multiple sheets of the paper P therein. The paper feeding tray 220, which can be separately formed from the paper feeding cassette 210, can be used primarily to supply a single sheet of the paper P or to manually supply various sizes of the paper P. The pick-up unit 230 can be configured to pick up the paper P from the paper feeding cassette 210 or from the paper feeding tray 220 and to guide the picked up paper P into a paper feeding path defined within the main body 10.

The paper feeding cassette 210 can include a knock-up plate 211 on which multiple sheets of the paper P can be stacked. One end of the knock-up plate 211 can be pivotally hinged on the paper feeding cassette 210, and can thereby be operated to selectively bring the stacked paper P into contact with the pick-up unit 230.

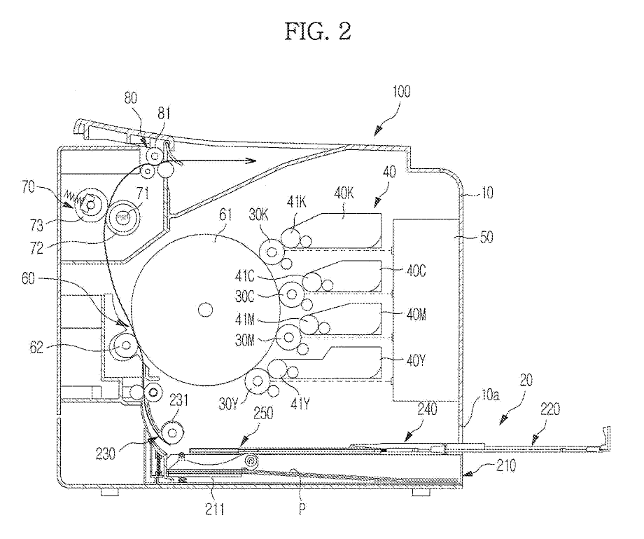

The paper feeding tray 220 can be movable between a first position in which the paper feeding tray 220 is withdrawn from the main body 10 so that the user can place one or more paper P thereon as shown in FIG. 2 and a second position in which the paper feeding tray 220 is inserted in the main body 10 as shown in FIG. 1. When the paper feeding tray 220 is in the second position, the paper P can be picked up by the pick-up unit 230. The main body 10 can include an opening that enables the paper feeding tray 220 to be installed in, and removed from, the main body 10 through the opening. Therefore, when the user places the paper P on the paper feeding tray 220 in the first position, and then moves the paper feeding tray 220 to the second position so that the leading edge of the paper P placed on the paper feeding tray 220 can be positioned under the pick-up unit 230, the paper P can reach the pick-up unit 230 without requiring a dedicated driving device.

The pick-up unit 230 can include a pick-up roller 231 rotatably mounted in the main body 10 and configured to pick-up the paper P, which can be placed on the paper feeding cassette 210 or on the paper feeding tray 220, and to guide the paper P into the paper feeding path.

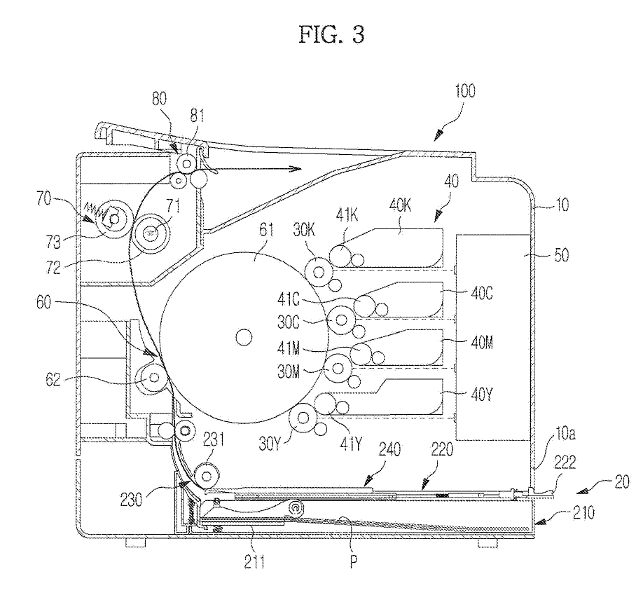

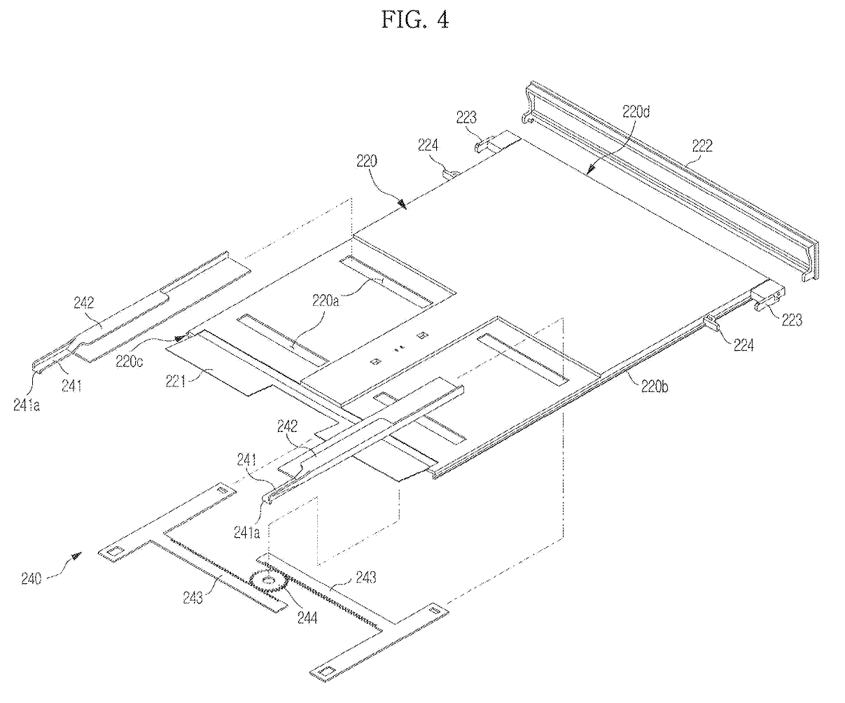

As shown in FIG. 4, a guide film 221 can be disposed at an inner end 220c of the paper feeding tray 220 to guide the paper P on the paper feeding tray 220 toward the pick-up unit 230. At an outer end 220d of the paper feeding tray 220, a cover 222 can be mounted to open and close the opening 10a. According to an embodiment of the present disclosure, because the cover 222 can be pivotably mounted on the outer end 220d of the paper feeding tray 220 to open and close the opening 10a, when a paper P longer than the paper feeding tray 220 is fed though the paper feeding tray 220, the opening 10a can remain open by pivoting the cover 222 as shown in FIG. 3, and the paper P can partly protrude out of the main body 10 through the opening 10a.

Referring back to FIG. 4, a guide unit 240 can be provided at the inner end 220c of the paper feeding tray 220 to guide the paper P being picked up from the paper feeding tray 220. More specifically, the guide unit 240 can include a stopper 241 configured to align the paper P by supporting the inner edge of the paper P, a pair of paper guides 242 configured to move along the width direction of the paper P to support both sides of the paper P placed on the paper feeding tray 220, a pair of rack gears 243, each of which is connected to one of the paper guides 242, and a pinion 244 configured to mesh with the pair of rack gears 243 so that the rack gears 243 operate in association with each other. In addition, the paper feeding tray 220 can include a guide slot 220a configured to allow the connection of the paper guide 242 with the rack gear 243 and to enable the paper guide 242 and the rack gear 243 to move along the width direction of the paper P.

The stopper 241 can include a blocking portion 241a that extends downward from an inner end of the stopper 241 to support the inner edge of the paper P. A stopper 241 can be integrally formed in each of the paper guides 242. The guide film 221 can extend upward and have an inward inclination from the paper feeding tray 220 to elastically contact a lower surface of the stopper 241. Accordingly, the paper P placed on the paper feeding tray 220 can be stably supported between the stopper 241 and the guide film 221.

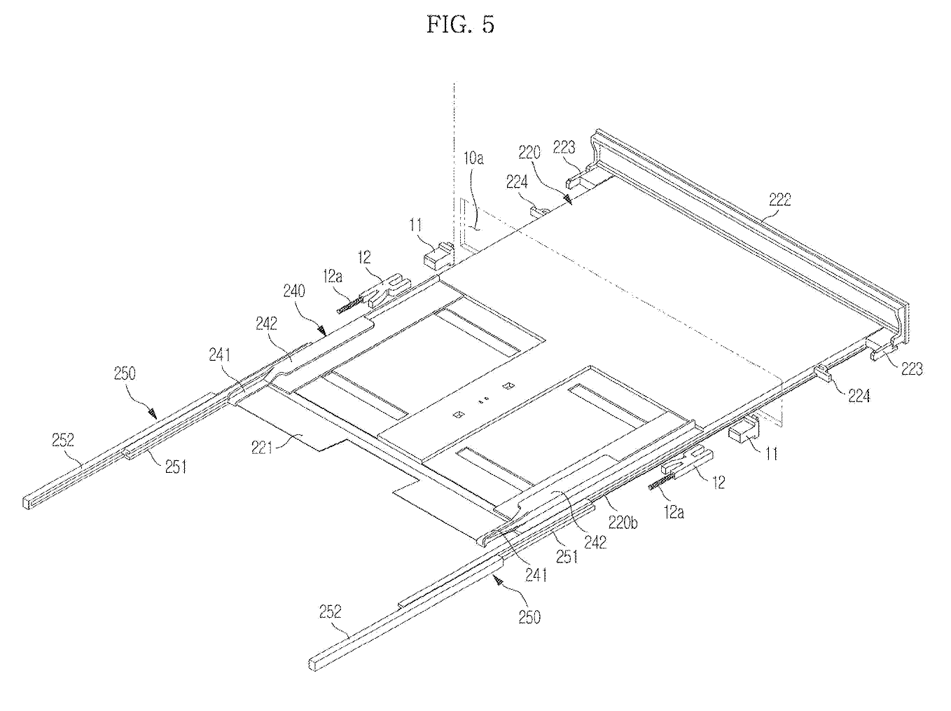

FIG. 5 shows a rail assembly 250 configured to allow the movable mounting of the paper feeding tray 220 to the main body 10. The rail assembly 250 can include first rails 251, each of which is movably mounted at both sides of the paper feeding tray 220, and second rails 252, which are mounted on the main body 10 and movably coupled with the first rails 251. Additionally, rail portions 220b can be formed at both sides of the paper feeding tray 220 to movably mount the first rails 251.

A hook 223 can be disposed in the paper feeding tray 220, and can be configured to be engaged with the main body 10 to maintain the mounted position of the paper feeding tray 220 in the main body 10. Correspondingly, a holder 11 for engagingly receiving the hook 223 can be disposed in the main body 10, that is, inside of the opening 10a.

Moreover, the image forming apparatus 100 can include an elastic supporting unit 12 configured to support the paper feeding tray 220 so that the paper feeding tray 220 can be separated easily from the main body 10. The elastic supporting unit 12 can be elastically supported by the main body 10 through an elastic member 12a. The elastic member 12a can be a spring, for example. The paper feeding tray 220 can include an elastic supported portion 224, which is engaged with the elastic supporting unit 12 so that the paper feeding tray 220 can be elastically supported by the main body 10 through the elastic supporting unit 12.

When the user exerts a force that moves the paper feeding tray 220 from the first position to the second position until the hook 223 is engaged with the holder 11, the user's force can be transferred through the elastic supported portion 224 to the elastic member 12a, with such a transfer resulting in an elastic deformation of the elastic member 12a.

When the user pushes on the paper feeding tray 220 toward the main body 10 while the paper feeding tray 220 is mounted on the main body 10, the hook 223 can be separated from the holder 11, causing the cover 222 of the paper feeding tray 220 to protrude out of the opening 10a by a predetermined distance by the operation of the recovery force of the elastic member 12a. As a result, the user can withdraw the paper feeding tray 220 with ease.

Hereinafter, use of the paper feeding tray 220 of the above-structured image forming apparatus 100 is described in greater detail.

To feed the paper P using the paper feeding tray 220, first, the paper feeding tray 220 can be moved to the first position to place the paper P thereon as shown in FIG. 2. While the paper feeding tray 220 is in the first position, the paper P can be placed between the pair of paper guides 242 on the paper feeding tray 220. Next, the paper guides 242 can be adjusted so that the both sides of the paper P are supported by the paper guides 242. When the paper P supported by the paper guides 242 is inserted into the main body 10 through the paper guides 242, the inner edge of the paper P can interact with the stopper 241 and therefore the paper P can be aligned. After the paper P is aligned, the paper feeding tray 220 can be moved to the second position as shown in FIG. 1 so that the paper P placed and aligned on the paper feeding tray 220 may be positioned under the pick-up roller 231.

When the paper feeding tray 220 is in the afore-described second position within the image forming apparatus 100, and when an image forming operation starts, the pick-up roller 231 can rotate, and can pick up the paper P from the paper feeding tray 220. When the paper P is picked up, the inner edge of the paper P can be aligned by the stopper 241 and both sides of the paper P can be supported by the paper guides 242. Skewed feeding of the paper P into the feeding path can be prevented because the paper P is picked up and fed under guidance of the paper guides 242.

Although the hook 223 can be disposed in the paper feeding tray 220 and the holder 11 can be disposed the main body 10 as shown in FIG. 5, those parts can be inversely provided, that is, the hook 223 can be disposed in the main body 10 and the holder 11 can be disposed in the paper feeding tray 220.

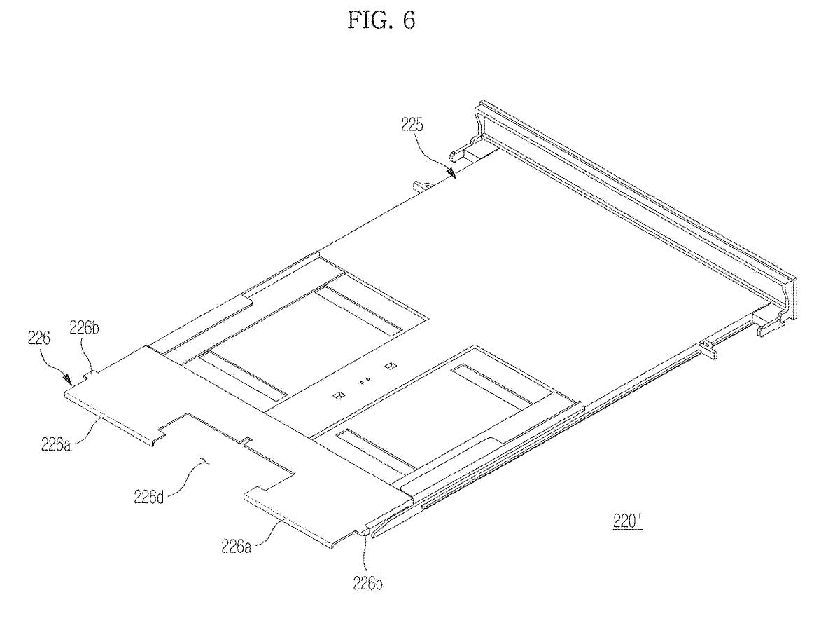

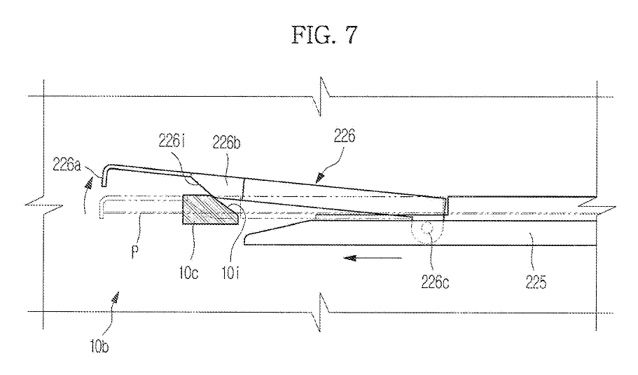

FIG. 6 is a perspective view showing a paper feeding tray applied to an image forming apparatus, according to another embodiment of the present disclosure, and FIG. 7 is a cross-sectional view illustrative of the operation of the paper feeding tray of FIG. 6.

The paper feeding tray 220′, according to an embodiment of the present disclosure, can also be movable between a first position in which the paper feeding tray 220′ is withdrawn from the main body 10 and a second position in which the paper feeding tray 220′ is inserted in the main body 10, as explained above with respect to FIG. 1 and FIG. 2.

Referring to FIG. 6 and FIG. 7, the paper feeding tray 220′ can include a tray body 225 configured to support the paper P and a shutter 226 pivotably formed at an inner end of the tray body 225. The shutter 226 can be disposed at an upper portion of the tray body 225 in a manner that one end of the shutter 226 is connected to the tray body 225.

When the paper P is supplied to the paper feeding tray 220′, the leading edge of the paper P can enter between the tray body 225 and the shutter 226. A blocking portion 226a can extend in a downward direction from the inner end of the shutter 226. The blocking portion 226a can align the leading edge of paper P entering between the tray body 225 and the shutter 226, thereby preventing skewed feeding of the paper P.

The shutter 226 can include an interference protrusion 226b that protrudes from a lateral side thereof. Although the interference protrusion 226b can be provided on both sides of the shutter 226 as illustrated in FIG. 6, this is shown by way of example. In other embodiments, a single interference protrusion 226b can be formed at one side of the shutter 226.

As shown in FIG. 7, on a lateral side 10b of the main body 10 facing the lateral side of the shutter 226, a shutter operating protrusion 10c can be configured to interact with the interference protrusion 226b. The shutter operating protrusion 10c can pivot the shutter 226 upward as the paper feeding tray 220′ moves from the first position to the second position as shown in FIG. 7. In other words, when the paper feeding tray 220′ is inserted in the main body 10, the shutter 226 can release the paper P from being restricted so that the paper P can be picked up.

The slant surfaces 226i and 10i can be further provided to the interference protrusion 226b and the shutter operating protrusion 10c, respectively, so that the interference protrusion 226b is able to move up and down along the shutter operating protrusion 10c more efficiently during the movement of the paper feeding tray 220′.

A reference symbol 226d (see FIG. 6) denotes an opening configured to enable the pick-up roller disposed above the shutter 226 to pick up the paper P when the paper feeding tray 220′ is inserted in the main body 10.

Although several embodiments have been shown and described, it would be appreciated by those skilled in the art that changes may be made in these embodiments without departing from the principles and spirit of the disclosure, the scope of which is defined in the claims and their equivalents.

What is claimed is:

1. An image forming apparatus, comprising:
a main body;
a printing medium cassette detachably supported in the main body; and
a printing medium tray provided on the main body separately from the printing medium cassette,
wherein each of the printing medium cassette and the printing medium tray is configured to receive one or more printing media on which to form an image, the printing medium tray being configured to move between a first position in which the printing medium tray is withdrawn from the main body to allow placement of a printing medium on the printing medium tray and a second position in which the printing medium tray is received into the main body to allow the printing medium placed on the printing medium tray to be picked up.

2. The image forming apparatus according to claim 1, wherein:
the printing medium tray includes a stopper configured to come into an interfering contact with, and to thereby align, a leading edge of the printing medium placed on the tray.

3. The image forming apparatus according to claim 1, further comprising a pick-up roller disposed above an end of the printing medium tray when the printing medium tray is in the second position, the pick-up roller being configured to pick up the printing medium selectively from the printing medium tray and from the printing medium cassette.

4. The image forming apparatus according to claim 2, wherein the stopper includes a blocking portion extending downward so as to come into a contact with and to thereby align the leading edge of the printing medium.

5. The image forming apparatus according to claim 2, wherein the printing medium tray includes a guide disposed at an inner end of the printing medium tray in such a manner to guide the leading edge of the printing medium toward the stopper, the inner end of the printing medium tray being a leading end of the printing medium tray with respect to a movement of the printing medium from the first position to the second position.

6. The image forming apparatus according to claim 1, wherein the printing medium tray includes a shutter pivotably mounted at an inner end of the printing medium tray, the shutter having a blocking portion configured to come into an interfering contact with, and to thereby align, a leading edge of the printing medium, the inner end of the printing medium being a leading end of the printing medium with respect to a movement of the printing medium from the first position to the second position.

7. The image forming apparatus according to claim 6, wherein the shutter includes a first protrusion formed on a side thereof, and
wherein the main body includes a second protrusion configured to interferingly contact the first protrusion of the shutter so as to cause the shutter to pivot in a direction moving the blocking portion of the shutter away from the leading edge of the printing medium as the printing medium tray moves from the first position to the second position.

8. The image forming apparatus according to claim 1, wherein the main body defines an opening through which the printing medium tray is received into the main body, and
wherein the printing medium tray includes a cover formed at an outer end opposite the leading end of the printing medium tray, the cover being configured to open and to close the opening.

9. The image forming apparatus according to claim 8, wherein the cover is pivotably mounted on the outer end of the tray.

10. The image forming apparatus according to claim 2, further comprising side guides configured to collectively guide both sides of the printing medium placed on the printing medium tray.

11. The image forming apparatus according to claim 10, wherein the stopper is formed integrally with at least one of the side guides.

12. The image forming apparatus according to claim 10, wherein the side guides are configured to be movable along a width direction of the printing medium, and
wherein the image forming apparatus further comprises a rack gear connected to each of the side guides and a pinion interconnecting the rack gears.

13. The image forming apparatus according to claim 1, further comprising a rail assembly configured to allow the printing medium tray to move between the first and second positions.

14. The image forming apparatus according to claim 13, wherein the rail assembly comprises:
first rails movably mounted on both sides of the printing medium tray, and
second rails mounted on the main body and movably coupled to the first rails.

15. The image forming apparatus according to claim 1, further comprising an elastic support member provided on one of the main body and the printing medium tray, the elastic support member being configured elastically bias the printing medium tray to move away from the main body toward the first position.

16. The image forming apparatus according to claim 1, further comprising locking members provided on the main body and the printing medium tray, the locking members being configured to engage each other so as to hold the printing medium tray in place within the main body.

17. An image forming apparatus, comprising:
a main body;
a printing medium tray having a tray surface on which a printing medium is to be placed, the printing medium tray being movably received in the main body so as to be capable of being at least partially protruding from the main body; and
a printing medium guide disposed adjacent the tray surface and configured to guide movement of the printing medium placed on the tray surface.

18. The image forming apparatus according to claim 17, wherein the printing medium guide includes a stopper having a portion configured to align a leading edge of the printing medium.

19. The image forming apparatus according to claim 18, wherein the printing medium guide includes side guides configured to guide both lateral edges of the printing medium.

20. The image forming apparatus according to claim 19, wherein the stopper is integrally formed with at least one the side guides.

21. The image forming apparatus according to claim 18, wherein the printing medium tray includes a guide disposed at an inner end of the printing medium tray in such a manner to guide the leading edge of the printing medium toward the stopper, the inner end of the printing medium tray being a leading end of the printing medium tray with respect to a movement of the printing medium in a direction of being received into the main body.

22. An image forming apparatus having a main body in which is supported a printing unit that forms an image on a printing medium, comprising:
a pick up roller supported in the main body;
a printing medium cassette detachably receivable in the main body and configured to receive therein a first capacity of printing media; and
a printing medium tray movably receivable in the main body and configured to receive therein a second capacity of printing media less than the first capacity of printing media,
wherein the pick up roller is configured to pick up the printing medium selectively from the printing medium cassette and from the printing medium tray and to convey the picked up printing media along a printing medium path toward the printing unit, the printing medium tray being configured to move between a first position in which the tray is at least partially withdrawn from the main body to allow placement of printing media on the printing medium tray and a second position in which the printing medium tray is received into the main body to allow the printing medium placed on the printing medium tray to be picked up by the pick up roller.

23. The image forming apparatus of claim 22, further comprising:
a printing medium guide disposed adjacent the printing medium tray and configured to align the printing medium placed on the printing medium tray.

24. The image forming apparatus according to claim 23, wherein the printing medium guide includes a blocking portion configured to come into an interfering contact with, and to thereby align, a leading edge of the printing medium placed on the printing medium tray.

25. The image forming apparatus of claim 24, wherein the printing medium guide is pivotably mounted at an end of the printing medium tray in such a manner the printing medium guide pivots in a direction moving the blocking portion of the printing medium guide away from the leading edge of the printing medium as the printing medium tray moves into the main body.
